(19) United States
(12) Patent Application Publication
(10) Pub. No.: US 2025/0340469 A1
(43) Pub. Date: Nov. 6, 2025

(54) ENVIRONMENTALLY SUSTAINABLE METHODS OF CONTROLLING CALCIUM CARBONATE SCALE IN INDUSTRIAL WATER SYSTEMS

(71) Applicant: CHEMTREAT, INC., Glen Allen, VA (US)

(72) Inventors: Rajendra Prasad KALAKODIMI, Glen Allen, VA (US); Santanu BANERJEE, Glen Allen, VA (US); Tzong Y. DU, Glen Allen, VA (US)

(73) Assignee: CHEMTREAT, INC., Glen Allen, VA (US)

(21) Appl. No.: 19/198,485

(22) Filed: May 5, 2025

Related U.S. Application Data
(60) Provisional application No. 63/642,267, filed on May 3, 2024.

(51) Int. Cl. C02F 5/10; C02F 1/00

(52) U.S. Cl. CPC C02F 5/10; C02F 1/008; C02F 2303/08; C02F 2303/22

(57) ABSTRACT

A method of treating water to inhibit calcium carbonate scaling. The method includes adding to the water a polymeric scale inhibitor having a polymer backbone with (i) a carboxylate component that includes at least two different carboxylic acid monomers, and (ii) a dispersion-enhancing monomer.

### CROSS-REFERENCE TO RELATED APPLICATIONS

This application claims the earlier filing date benefit of U.S. Provisional Application No. 63/642,267, filed on May 3, 2024. The entirety of this earlier application is incorporated by reference herein.

### BACKGROUND

Organic phosphates such as PBTC and HEDP are commonly used as calcium scale inhibitors in industrial water treatment. However, organic phosphates contain phosphorus which can promote the toxic growth of blue-green algae in cooling towers and ponds. This, in turn, requires increased the usage of biocides and chlorine. Increasing environmental regulations limit phosphorus discharge due to its role in eutrophication. The EPA has stated that nutrient pollution from nitrogen and phosphorus is one of the most expensive environmental problems in the United States.

Another challenge with organic phosphates like PBTC and HEDP is that they can revert to ortho-phosphate in the presence of halogens from oxidizing biocides or high return water temperature in cooling water applications, resulting in calcium phosphate scale formation. And, in water with higher calcium-hardness chemistry, HEDP forms the calcium-HEDP complex due to a limited calcium tolerance issue. Because of these challenges, there is no easy method to control their dosing and maintain an accurate residual in cooling water applications. Inaccurate measurement for HEDP residual can lead to over or under-dosing, which can cause scaling risk in water systems.

In some cases, homopolymers of a carboxylic acid monomer, such as polyacrylic acid, have been used as a scale inhibitor for calcium carbonate. However, here also, there are no available methods for controlling the concentration of these polymers in a water system. Additionally, available polymers cannot be used in high-stressed waters because they do not adequately disperse in such waters.

### SUMMARY

This disclosure provides a new polymer for controlling calcium carbonate scale in industrial water systems that can overcome one or more of the above-mentioned deficiencies. Thus, according to one aspect, this disclosure provides a method of treating water that is prone to calcium scaling. The method includes adding to the water a polymeric scale inhibitor having a polymer backbone with (i) a carboxylate component that includes at least two different carboxylic acid monomers, and (ii) a dispersion-enhancing monomer.

### BRIEF DESCRIPTION OF THE DRAWINGS

FIG. 1 is a graph illustrating the efficacy of a polymeric scale inhibitor in inhibiting calcium carbonate scale compared to commercially available products;

FIG. 2 is a graph illustrating the ability of a tagged polymeric scale inhibitor to monitor changes in stress of the water;

FIG. 3. is a graph showing the dispersion properties of a tagged polymeric scale inhibitor in the presence of metal ions;

FIG. 4 is a graph showing the dispersion properties of a polymeric scale inhibitor in the presence of clay; and

FIGS. 5A and 5B are graphs showing the thermal stability of a tagged polymeric scale inhibitor over time;

FIG. 6 is a graph showing the pH stability of a tagged polymeric scale inhibitor;

FIG. 7 is a graph showing the stability of a tagged polymeric scale inhibitor in the presence of different oxidizing biocides;

FIG. 8 is a graph showing the effect of calcium carbonate precipitation on the active tagged polymeric scale inhibitor; and

FIGS. 9A and 9B are graphs showing the results of a field trial in which the residual tagged scale inhibitor was measured and used to determine product dosage.

### DETAILED DESCRIPTION OF EMBODIMENTS

In connection with this disclosure, new scale-inhibition polymers have been found that exhibit high calcium carbonate scale-inhibition performance, are environmentally beneficial, and are useful to treat high-stressed industrial waters. The polymers can also optionally be tagged with a detectable monomer to assist in monitoring and controlling the dosing or residual amount of scale inhibitor. The polymers may be useful in inhibiting scaling on equipment or conduits that are in contact with water which is prone to calcium carbonate scale, e.g., cooling water streams, makeup water streams, water retained by reverse osmosis membranes, etc.

The scale-inhibition polymers includes a polymer backbone that includes (i.e., is formed from) (i) a carboxylate component that includes at least two different carboxylic acid monomers, and (ii) a dispersion-enhancing monomer.

The carboxylate component can include two or more different carboxylic acid monomers, such as from two to four carboxylic acid monomers. By way of example, the carboxylic acid monomers can be selected from, but are not limited to, itaconic acid, butanoic acid, ethylmalonic acid, succinic acid, acrylic acid, citraconic acid, crotonic acid, methacrylic acid, malonic acid, maleic acid, fumaric acid, and aconitic acid.

The dispersion-enhancing monomer is a monomer that is effective to improve the dispersion of the suspended solids, phosphates, metal oxides, etc. in water as compared to a like polymer that does not include the dispersion-enhancing monomer. The dispersion-enhancing monomer can include, but is not limited to, a sulfonic acid monomer that has at least one sulfonate group.

In some embodiments, the scale-inhibition polymer can include from 10 to 95 mol % or 40 to 80 mol % of the carboxylate component (i.e., mol % of the carboxylic acid monomers combined), and from 5 to 40 mol % or 10 to 30 mol % of the dispersion-enhancing monomer.

Optionally, the scale-inhibition polymers can be tagged with a detectable monomer such as a fluorescent monomer or other optically detectable monomer that is incorporated into the polymer backbone, which allows the amount of the scale-inhibitor to monitored and controlled as described in more detail below. The detectable monomer can be a naphthalene-based monomer, for example. The polymeric scale inhibitor can include a detectable monomer in amounts of from 0.005 to 5 mol %, from 0.01 to 2.5 mol %, or from 0.1 to 1 mol %, for example.

Advantageously, the scale-inhibition polymers described herein are substantially free (i.e., at least 90 wt. %), at least 99 wt. %, or entirely free of phosphorous. As indicated above, the use of organic phosphates as a calcium carbonate scale-inhibitor is common, but is detrimental to the environment due to phosphorous in water that is discharged. The polymers discovered in connection with the present invention are remarkably effective at inhibiting calcium carbonate scale while adding no phosphorous to the water.

The molecular weight of the polymer can be in a range of from 400 to 15,000 Daltons, or 500 to 10,000 Daltons.

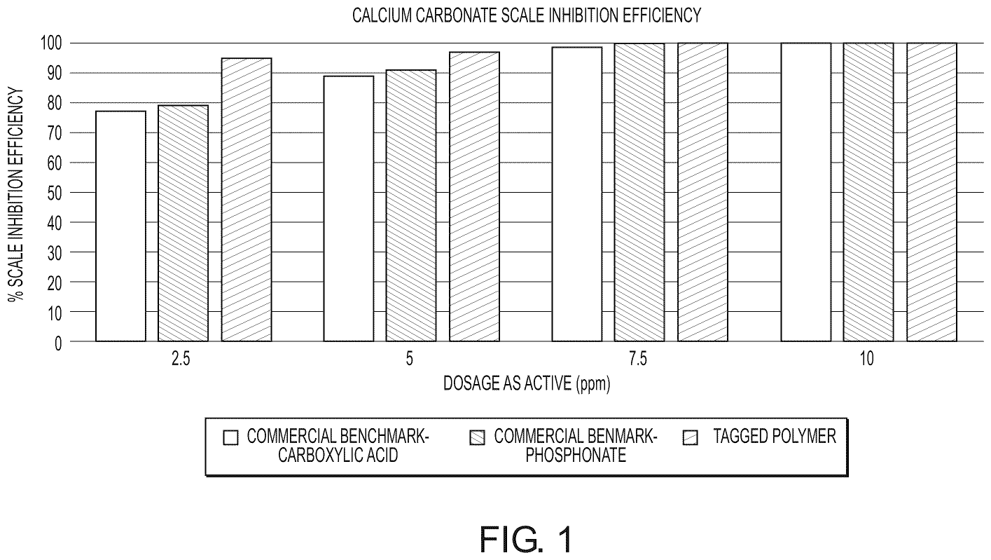

The polymeric scale inhibitor described herein is remarkably effective at inhibiting calcium carbonate scale over a wide range of dosages, and shows comparable or better scale inhibition efficiency than other commercial carboxylic acid or phosphonate scale inhibitor products. FIG. 1 illustrates that dosages as low as 2.5 ppm are effective to inhibit over 95% of calcium carbonate scale under a high LSI range of 2.2-3.0 or 2.5-2.75, which is considered to be excellent. As can be seen in FIG. 1, other polymeric inhibitors such as a polyacrylic acid homopolymer or a phosphonate scale inhibitor exhibit an efficiency of less than 80% when dosed at 2.5 ppm. These products need to be dosed in amounts of at least 7.5 ppm to achieve comparable efficacy as the polymeric scale inhibitor described herein. Thus, in some aspects, the polymeric scale inhibitor of the invention can be added to the water in amounts of 3 ppm or less, or from 0.5 to 2.5 ppm, and still surprisingly achieve an excellent level of calcium carbonate scale inhibition. In other aspects, the dosage of the polymeric scale inhibitor can be in a range of from 0.1 to 50 ppm, from 0.5 to 15 ppm, or from 1 to 10 ppm, for example.

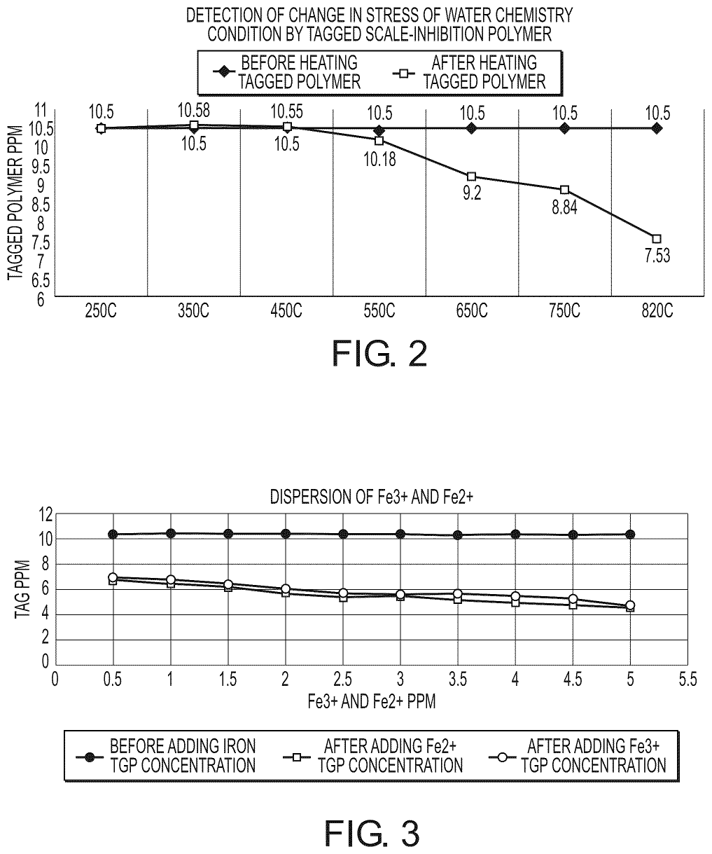

In embodiments where the polymeric scale inhibitor is tagged with a detectable monomer, the scale inhibitor can be monitored to detect changes in the stress to the water. In FIG. 2 stress is imparted to the system by increasing the pH. FIG. 2 shows that the reading of the tagged polymer starts to drop slightly before the difference in total and filtered calcium (an indicator of the formation of bulk phase calcium, which can form scale) appears to show a difference. This indicates that the tagged polymeric scale inhibitor can be used as a measure of the stress in the system and can be used as an early detection of a potential scaling event.

As described above, one drawback of using polymeric scale-inhibitors is that they do not disperse well in high stressed waters, e.g., waters having high temperatures, high iron content, high calcium content, high clay content, and/or high suspended solids. The scale-inhibitors described herein have improved dispersion and can be used to inhibit calcium carbonate scale even in high-stressed water such as can be found in chemical plants, petroleum refineries, and other heavy industries. The polymeric scale inhibitors are also compatible with reverse osmosis membranes.

In some aspects, this invention provides for methods of treating high stressed water by adding the polymeric scale inhibitor to water that includes at least one of the following characteristics: (i) an iron amount (as Fe3+ or Fe2+ ions) of 0.1 ppm to 10 ppm, at least 3 ppm, or from 3 to 20 ppm; (ii) a calcium amount (as Ca2+ ions) in a range of from 100 to 1500 ppm, at least 600 ppm, or from 700 to 2000 ppm; (iii) an amount of total suspended solids (TSS) that is from 10 to 500 ppm or from 25 to 100 ppm; and (iv) a turbidity in a range of 10 to 500 NTU, from 25 to 250 NTU, or at least 50 NTU, for example.

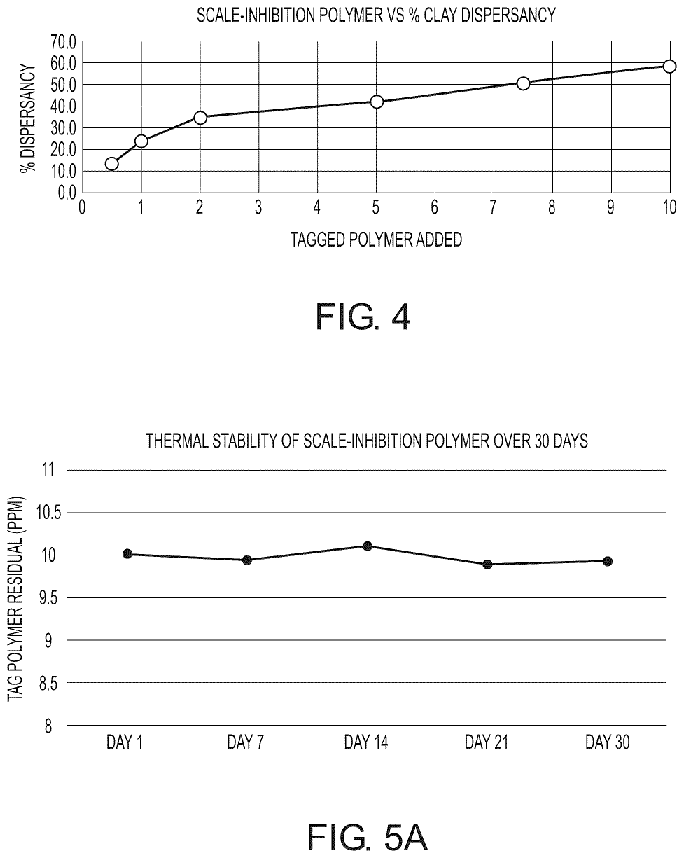

The calcium carbonate scale inhibitors described herein have been shown to have excellent metal and clay dispersion properties. FIG. 3 illustrates the dispersion of a tagged scale inhibitor according to this disclosure with varying concentrations of Fe2+ and Fe3+ ions in the water. In FIG. 3, “TGP” means the tagged polymeric scale inhibitor. FIG. 4 illustrates the dispersancy of the tagged scale inhibition polymer over varying amounts in the presence of the water containing high levels of clay or suspended solids.

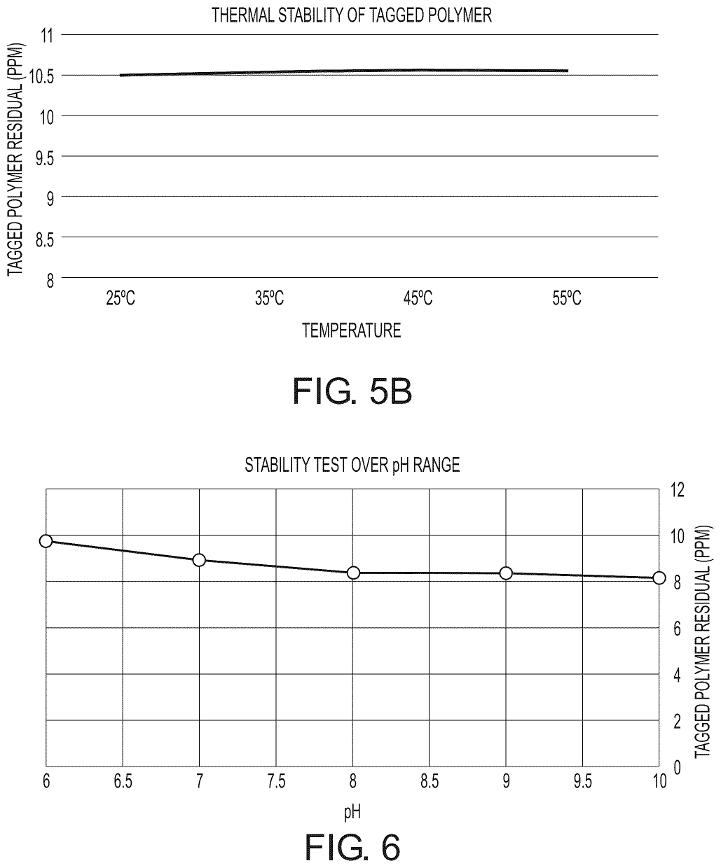

FIG. 5A illustrates the thermal stability of the tagged scale inhibition polymer over time when added in an amount of 10 ppm to water that is held at a temperature of 50° C. As can be seen, the residual polymer remains stable in the water over at least 30 days. FIG. 5B illustrates that the scale inhibition polymer has excellent thermal stability in water over temperatures ranging from 25° C. to 55° C. FIG. 6 illustrates that the tagged scale inhibition polymer has good stability over at least a pH range of from 6 to 10.

In some aspects, the scale-inhibitors described herein can be used to substantially supplant or to fully replace the use of phosphorous-containing scale inhibitors in waters that are prone to calcium carbonate scaling. Thus, in some embodiments, the water can be treated by adding the scale-inhibition polymers of the invention to water in the absence of organic phosphorous-containing compounds such as phosphonates, phosphinates, and polyphosphates, or with only very minor amounts of these type of compounds, e.g., less than 0.5 ppm, less than 0.1 ppm, or less than 0.01 ppm. In addition to the environmental benefits described above, completely or substantially replacing phosphorous-containing scale inhibitors with the polymeric scale inhibitors described herein can also reduce the formation of calcium phosphate scale.

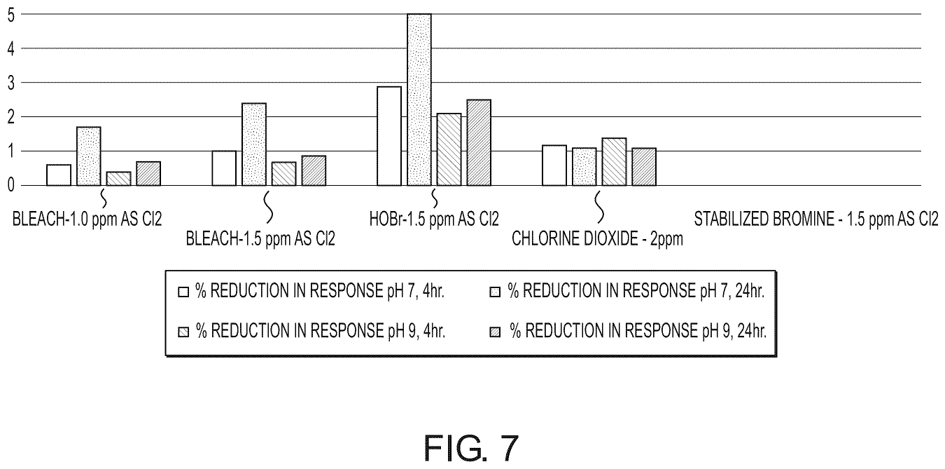

And, unlike organic phosphates, the scale inhibitors described herein are stable in the presence of oxidizing biocides, including halogen containing biocides. FIG. 7 illustrates the stability of the scale inhibitor in the presence of bleach (1.0 ppm as Cl₂ and 1.5 ppm as Cl₂), hypobromous acid, chlorine dioxide, and stabilized bromine at pH values of 7 and 9, and after 4 hr and 24 hr. In each case the scale inhibitor exhibited a reduction in response of less than 5%. Thus, in some aspects, the scale inhibitor can be added to water that includes such oxidizing biocides, e.g., in amounts of from 0.1 to 5 ppm, 0.2 to 3 ppm, or 0.1 to 1 ppm, for example.

In some aspects, the polymeric scale inhibitor can be added to the water in conjunction with other common calcium scale inhibitors and/or other dispersant polymers. Likewise, in some embodiments, the polymeric scale inhibitor can be added to the water with a corrosion inhibitor. The components of this combined treatment can be added to the water separately or can be combined into a single formulation that is dosed.

In embodiments where the polymeric scale inhibitor is tagged with a detectable monomer, the concentration of the scale inhibitor in the water can advantageously be monitored by detecting the detectable monomer with a fluorescent probe or other optical detector. The detector can measure an optical property (e.g., fluorescence) of the detectable monomer at any location downstream of where the scale inhibitor is added to the water. The detector can relay a signal to a controller (e.g., via wires or wirelessly) that is indicative of the measured value. A controller can calculate the level of scale inhibitor from the measured value and automatically adjust parameters such as the dosing rate of the scale inhibitor in response to the detected information. The levels of scale inhibitor (and optionally other measured parameters such as pH, temperature, and flow rate) can also be recorded and correlated with a measured degree of scaling in order to optimize the process conditions or the dosing amount of the scale inhibitor. The controller can communicate with a user interface in which threshold values or set point values for the amount of scale inhibitor can be set, and stored in a memory.

An advantage of being able to take online measurements of the tagged scale inhibitor is that it enables the active chemistry levels to be regulated and maintained even during fluctuations in the cooling system, such as stress resulting from changes in water quality, heat load, higher fouling potential, operational changes, etc. A key variable is the bulk phase precipitation of calcium carbonate (CaCO3), which can influence the residual active levels of the tagged polymer in the water system. When mineral solubility exceeds saturation and CaCO3 forms in the bulk phase, some active scale inhibitor precipitates with the CaCO3 scale.

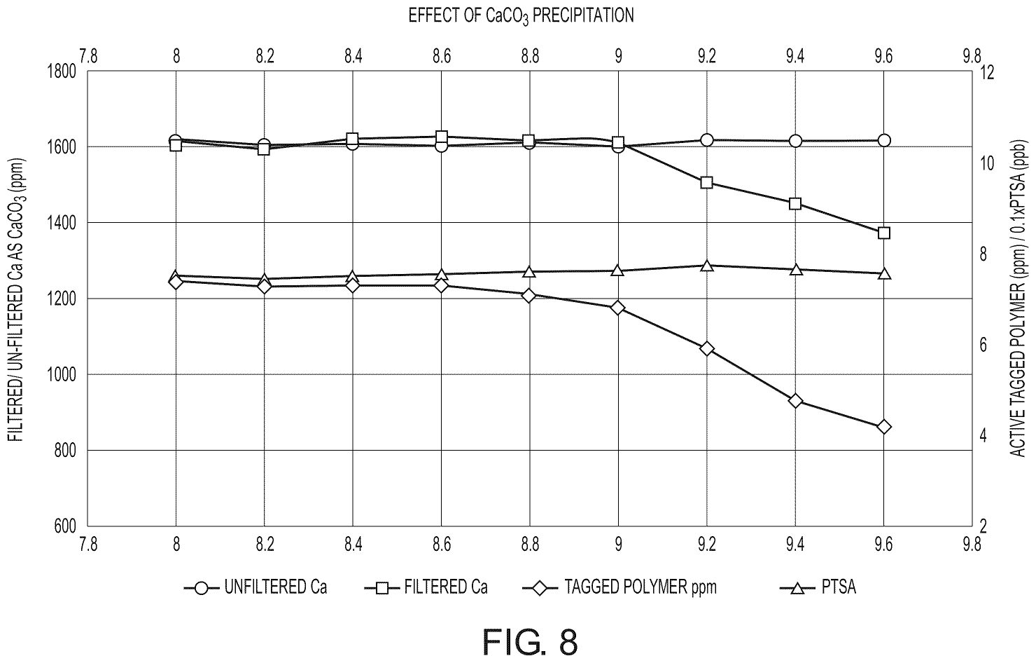

This phenomenon is illustrated in FIG. 8. In FIG. 8, a solution was prepared containing 7.5 ppm tagged scale inhibitor polymer in water with 1800 ppm calcium as CaCO3, 600 ppm magnesium as CaCO3, 150 ppm M-alkalinity as CaCO3, 400 ppm sulfate (SO4⁻²), 400 ppm chloride (Cl⁻), and 100 ppb 1,3,6,8-pyrene tetra sulfonic acid (PTSA) at 50° C. The solution was titrated with IN NaOH to incrementally increase the pH, during which time the responses from the tag (PTSA) and active tagged scale inhibitor polymer were continuously measured alongside filtered (F) and unfiltered (UF) calcium concentrations (unfiltered calcium represents the total calcium concentration in the water). With the increase in pH (x-axis), bulk-phase CaCO3 precipitation began as indicated by the widening gap between total and filtered calcium, and the active tagged polymer levels decreased because the deposit control agents were consumed by the CaCO3 precipitate. In this regard, as the CaCO3 scale begins to precipitate, it incorporates some of the calcium carbonate scale control agents.

The ability to actively measure the tagged polymer by fluorescence can provide an early warning of CaCO3 precipitation, which enables prompt corrective measures to be taken. This allows industries to operate safely at higher alkaline pH levels without the risk of potential CaCO3 scaling. If active tagged scale inhibitor levels start to drop, the response can be communicated to the tagged scale inhibitor feed pump for readjustment to mitigate scaling issues. Measuring the concentration of active tagged scale inhibitor is superior to the common alternative practice of using a fluorescent tracer dye (e.g., PTSA) in the formulation. The drawback of using a tracer dye approach is shown in FIG. 8, where the inert tracer (PTSA) response shows minimal change during the CaCO3 precipitation event. Therefore, relying solely on PTSA readings could potentially cause an operator to neglect or overlook decreasing active polymer levels in the system and cause potential deposition occurrences.

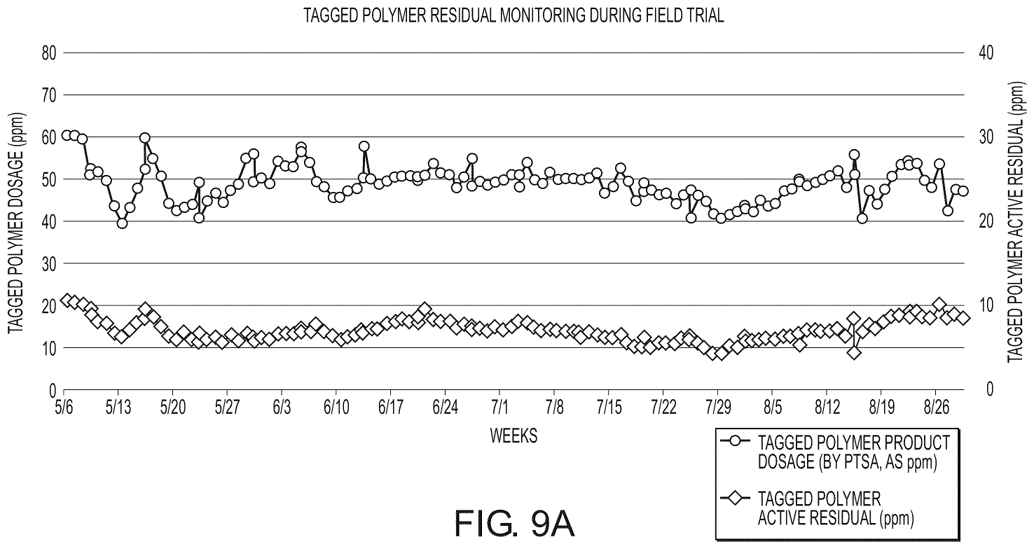

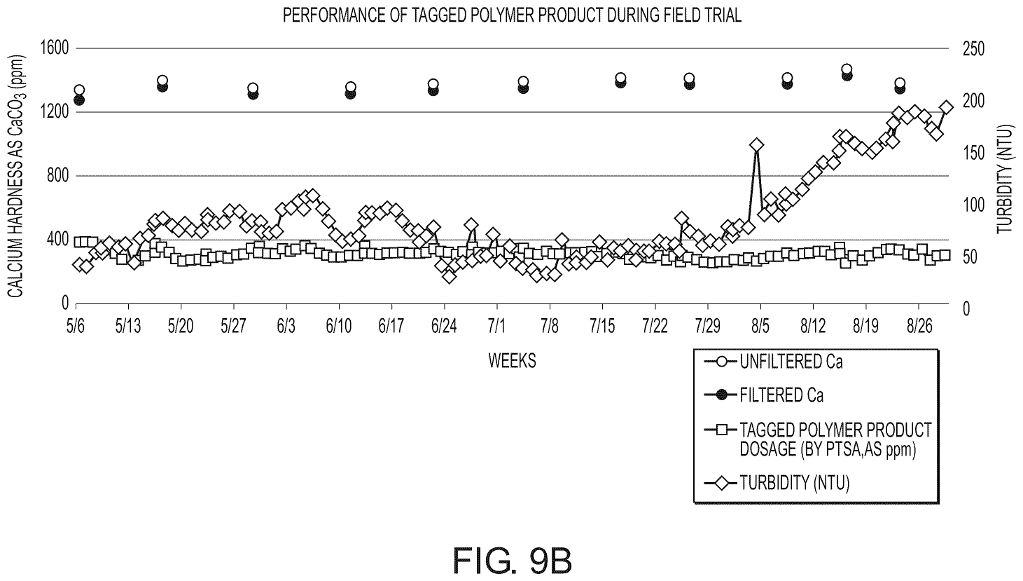

FIGS. 9A and 9B illustrate the results of a field trial in which the fluorescence of the tagged scale inhibitor was measured to provide real-time tracking of scale inhibitor demand in a cooling water system. The tagged scale inhibitor was tracked by PTSA as product (ppm) and the corresponding active tagged scale inhibitor (ppm). The product dosing was automatically controlled based on the fluorescent readings from the tagged polymer to maintain the product dosing at a set level. When the readings from the tag decline below a target level, an automated process triggers an adjustment in the product feed, ensuring that the necessary dosage is maintained in the water seamlessly. Routine measurements of the fluorescent tag indicated a consistent presence of the required active polymer residual within the cooling water.

FIG. 9B also shows that the levels of the tagged scale inhibitor polymer can be consistently maintained even when water coming from a natural lake is used as the make-up water for the cooling tower, and the turbidity of the make-up water is high and variable. Also, the minimal variation in filtered calcium hardness suggests a dramatic reduction in scale deposition levels. After several months of use, the tagged scale inhibitor and automated dosing scheme was deemed to provide good scale deposition management. This field trial also shows that the automatic control of the scale inhibitor enables high turbidity make-up water to be used without compromising performance.

It will be appreciated that the above-disclosed features and functions, or alternatives thereof, may be desirably combined into different methods. Also, various alternatives, modifications, variations or improvements may be subsequently made by those skilled in the art, and are also intended to be encompassed by the disclosed embodiments. As such, various changes may be made without departing from the spirit and scope of this disclosure.

What is claimed is:

1. A method of treating water that is prone to calcium scaling, the method comprising adding to the water a polymeric scale inhibitor having a polymer backbone with (i) a carboxylate component that includes at least two different carboxylic acid monomers, and (ii) a dispersion-enhancing monomer.

2. The method of claim 1, wherein polymer backbone further includes a detectable monomer.

3. The method of claim 2, wherein the detectable monomer is a fluorescent monomer.

4. The method of claim 1, wherein the polymeric scale inhibitor is substantially free of phosphorous.

5. The method of claim 1, wherein no organic phosphate compounds are added to the water.

6. The method of claim 1, wherein less than 3 ppm of organic phosphate compounds are added to the water.

7. The method of claim 1, wherein the polymeric scale inhibitor is added to the water in an amount of from 1 to 15 ppm.

8. The method of claim 1, wherein the water that is prone to calcium scaling has one or more of the following characteristics: (i) an iron amount, as Fe3+ or Fe2+ ions, of at least 0.1 to 10 ppm; and (ii) a calcium amount of in a range of from 100-1500 ppm.

9. The method of claim 1, wherein the polymeric scale inhibitor includes 10 to 95 mol % of the carboxylate component and from 5 to 40 mol % of the dispersion-enhancing monomer.

10. The method of claim 1, wherein the dispersion-enhancing monomer is a sulfonate monomer with at least one sulfonate group.

11. The method of claim 2, further comprising, after adding the polymeric scale inhibitor to the water, measuring an optical property of the detectable monomer.

12. The method of claim 11, further comprising determining a concentration of the polymeric scale inhibitor in the water based on the measured optical property.

13. The method of claim 12, further comprising adjusting the amount of the polymeric scale inhibitor that is added to the water based on the determined concentration of the polymeric scale inhibitor.

14. The method of claim 1, wherein the at least two carboxylic acid monomers are selected from the group consisting of itaconic acid, butanoic acid, ethylmalonic acid, succinic acid, acrylic acid, citraconic acid, crotonic acid, methacrylic acid, malonic acid, maleic acid, fumaric acid, and aconitic acid.

15. The method of claim 1, wherein the carboxylate component includes from two to four different carboxylic acid monomers.

16. The method of claim 1, wherein the polymeric scale inhibitor is added to the water in conjunction with other calcium scale inhibitors and/or other dispersion polymers.

17. The method of claim 1, wherein the polymeric scale inhibitor is added to the water in conjunction with other scale inhibitors, other dispersant polymers, and a corrosion inhibitor.
